(19) United States
(12) Patent Application Publication
(10) Pub. No.: US 2018/0054608 A1
(43) Pub. Date: Feb. 22, 2018

(54) IMAGE CAPTURING DEVICE AND IMAGE CAPTURING METHOD

(71) Applicants: LITE-ON ELECTRONICS (GUANGZHOU) LIMITED, GUANGZHOU (CN); Lite-On Technology Corporation, Taipei (TW)

(72) Inventor: Jau-Yu Chen, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/352,582

(22) Filed: Nov. 16, 2016

(30) Foreign Application Priority Data
Aug. 19, 2016 (CN) 201610693423.5

(51) Int. Cl. H04N 13/02

(52) U.S. Cl. CPC H04N 13/0246; H04N 2013/0081; H04N 13/0253; H04N 13/0242

(57) ABSTRACT

An image capturing device including a first image capturing module and a second image capturing module. The first image capturing module includes a first light source and a first depth detection component, and the second image capturing module includes a second light source and a second depth detection component. The first light source is adapted to emit a first light to a first detection area, and the first depth detection component is adapted to receive the reflected first light, so as to acquire the first depth information. The second light source is adapted to emit a second light to a second detection area, and the second depth detection component is adapted to receive the reflected second light for acquiring the second depth information. The first and second detection areas are substantially adjacent to each other, and the first and second light sources alternately emit the first and second lights.

### CROSS-REFERENCE TO RELATED APPLICATION

This application claims the priority benefit of China application no. 201610693423.5, filed on Aug. 19, 2016. The entirety of the above-mentioned patent application is hereby incorporated by reference herein and made a part of this specification.

### BACKGROUND OF THE INVENTION

### 1. Field of the Invention

The present invention relates to an optical device and an optical processing method. More specifically, the present invention relates to an image capturing device and an image capturing method.

### 2. Description of Related Art

As technology advances, time-of-flight cameras (TOF cameras) can acquire a distance between each point in an image and a camera with the conversion of light speed, so as to acquire a three dimensional image information of a space. With the aforementioned time-of-flight camera, the motion, gesture and the like of a person to be recorded can be recorded. When the time-of-flight camera is electronically connected to an electronic device, the person to be recorded can even control the electronic device with various gestures and motions, so as to provide a convenient control environment.

However, current time-of-flight cameras have limitations in field of view, the time-of-flight cameras can only detect objects in a fixed field of view. In addition, since the time-of-flight cameras have to provide detection lights simultaneously, the detection lights would interfere with each other and cause misjudgements when multiple time-of-flight cameras are operated in the same space simultaneously. Moreover, the reflection of the detection lights would also cause misjudgements due to the differences of the reflectivity, the absorption rate and the surface smoothness of the surface of the detected object.

### SUMMARY OF THE INVENTION

The present invention is directed to an image capturing device, adapted to capture wide-angle depth information.

The present invention is directed to an image capturing method, adapted to effectively capture wide-angle depth information.

The image capturing device of the embodiment of the present invention includes at least one first image capturing module and at least one second image capturing module. The first image capturing module includes a first light source and a first depth detection component. The second image capturing module includes a second light source and a second depth detection component. The first light source is adapted to emit a first light to a first detection area. The first depth detection component is adapted to receive the first light reflected from the first detection area, so as to acquire a first depth information. The second light source is adapted to emit a second light to a second detection area. The second depth detection component is adapted to receive the second light reflected from the second detection area, so as to acquire a second depth information. The first detection area and the second detection area are substantially adjacent to each other or partially overlapped, and the first light source of the first image capturing module and the second light source of the second image capturing module alternately emit the first light and the second light.

In an embodiment of the present invention, the first image capturing module further includes a first image capturing component, the second image capturing module further includes a second image capturing component. The first image capturing component is adapted to capture an image of the first detection area. The second image capturing component is adapted to capture an image of the second detection area.

In an embodiment of the present invention, the first image capturing module and the second image capturing module are disposed around a central axis. The first light source of the first image capturing module and the second light source of the second image capturing module emit the first light and the second light outward with the central axis as the center.

In an embodiment of the present invention, the first depth detection component of the first image capturing module calculates a distance according to a propagation time of the first light, and the second depth detection component of the second image capturing module calculates a distance according to a propagation time of the second light.

In an embodiment of the present invention, the first light source of the first image capturing module and the second light source of the second image capturing module are laser light sources.

In an embodiment of the present invention, the image capturing device further includes a control device. The control device is electrically connected to the first image capturing module and the second image capturing module, and alternately activates the first image capturing module and the second image capturing module.

In an embodiment of the present invention, the image capturing device includes three first image capturing modules and three second image capturing modules. The three first image capturing modules and the three second image capturing modules are alternately disposed and surround a central axis. The three first image capturing modules capture the three first depth information respectively along different angles. The three second image capturing modules capture the three second depth information respectively along different angles. The three first detection areas and the three second detection areas alternately surround the image capturing device along the central axis.

In an embodiment of the present invention, the first detection area and the second detection area are substantially complementary.

The image capturing method of the embodiment of the present invention includes driving a first depth detection step, driving a second depth detection step, and converting a first depth information and a second depth information to an environment depth information. The first depth detection step includes emitting a first light to a first detection area; and receiving the first light reflected from the first detection area with a first depth detection component, generating a first depth information. The second depth detection step includes emitting a second light to a second detection area, and the second detection area and the first detection area are adjacent to each other or partially overlapped; and receiving the second light reflected from the second detection area by a second depth detection component, so as to generate a second depth information, wherein the first light and the second light are alternately emitted.

In an embodiment of the present invention, the first depth detection step further includes capturing an image of the first detection area by a first image capturing component; and calibrating the first depth information according to the image of the first detection area. The second depth detection step further includes capturing an image of the second detection area by the second image capturing component; and calibrating the second depth information according to the image of the second detection area.

In an embodiment of the present invention, a step of calibrating the first depth information according to the image of the first detection area further includes: converting an image of the first detection area to an image contour of the first detection area; and removing noise of the first depth information according to the image contour of the first detection area. A step of calibrating the second depth information according to the image of the second detection area further includes: converting an image of the second detection area to an image contour of the second detection area; and adjusting the second depth information according to the image contour of the second detection area.

In an embodiment of the present invention, after the first depth detection step repeatedly executes a number of measurements, the second depth detection step repeatedly executes the number of measurements.

In an embodiment of the present invention, the first depth detection step and the second depth detection step repeatedly drive alternately.

In an embodiment of the present invention, the first detection area and the second detection area are substantially complementary.

Based on the above, the image capturing device of the embodiment of the present invention can obtain wide-angle depth information, because it can alternately drive the first image capturing module and the second image capturing module to respectively acquire the first depth information and the second depth information. Therefore, the image capturing device of the present invention may increase the overall field of view, and the noise generated in response to interference between the lights from the first image capturing module and the second image capturing module can be greatly decreased. The image capturing method of the embodiment of the present invention can acquire favorable first depth information and second depth info' nation to generate the environment depth information, because it can alternately drive the first depth detection step and the second depth detection step.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 3B are schematic diagrams of the image capturing device according to the first embodiment of the present invention.

FIG. 4 and FIG. 5 are schematic diagrams of the image capturing device according to the second embodiment of the present invention.

FIG. 6 is a schematic flowchart of the image capturing method according to the first embodiment of the present invention.

FIG. 7 is a schematic flowchart of the image capturing method according to the third embodiment of the present invention.

FIG. 8 is a schematic flowchart of the image capturing method according to the fourth embodiment of the present invention.

FIG. 9A to FIG. 9C are schematic diagrams of noise filtering of the depth information according to the fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

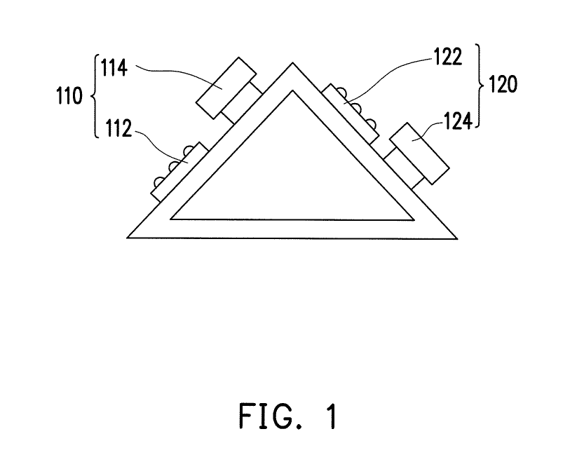

FIG. 1 to FIG. 3B are schematic diagrams of the image capturing device according to the first embodiment of the present invention. Referring to FIG. 1, in the first embodiment of the present invention, the image capturing device 100 includes a first image capturing module 110 and a second image capturing module 120. The first image capturing module 110 is adapted to capture a first depth information. The second image capturing module 120 is adapted to capture a second depth information. In embodiment, the image capturing device 100 can be installed indoors. The image capturing device 100 includes a housing, and the first image capturing module 110 and the second image capturing module 120 are disposed on the housing.

For example, the housing can be a triangle housing as shown in FIG. 1. The housing can be fixed on, for example, a wall via the long side of the triangle. Moreover, the first image capturing module 110 and the second image capturing module 120 can be respectively disposed on the two symmetrical short sides of the triangle housing.

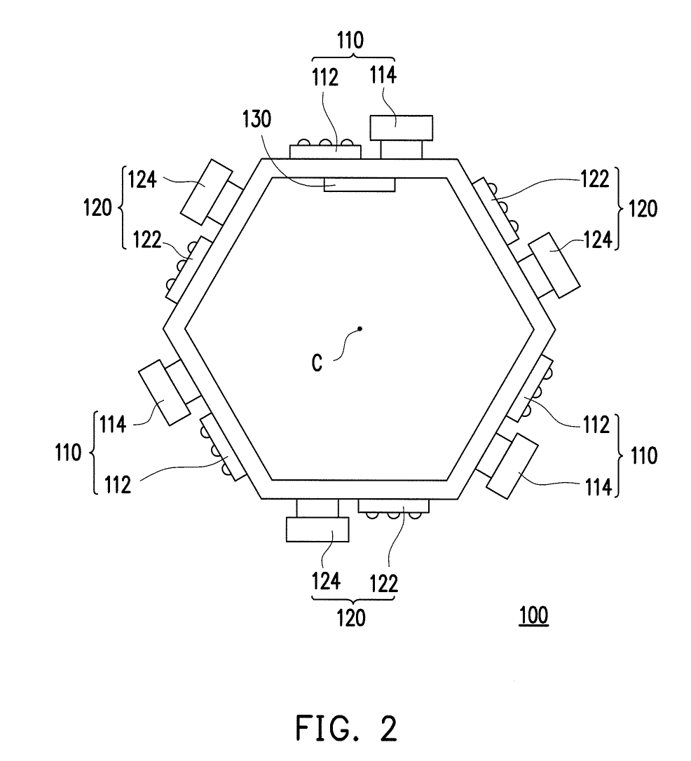

Furthermore, the housing can be a hexagon housing as shown in FIG. 2. The three first image capturing modules 110 and the three second image capturing modules 120 can be alternately arranged on different sides of the hexagon housing. In the present embodiment, the shape of the housing and the configuration and number of the first image capturing module 110 and the second image capturing module 120 can be adjusted appropriately according to actual needs.

The first image capturing module 110 of the present embodiment includes a first light source 112 and a first depth detection component 114. The second image capturing module 120 includes a second light source 122 and a second depth detection component 124. The first light source 112 and the first depth detection component 114 are disposed adjacent to each other, and are in a disposition relation that is, for example, disposed left and right or top and bottom. Moreover, the second light source 122 and the second depth detection component 124 are also disposed adjacent to each other.

The second light source 122 and the second depth detection component 124 can also adopt a disposition relation that is disposed left and right or top and bottom according to usage requirements or design considerations.

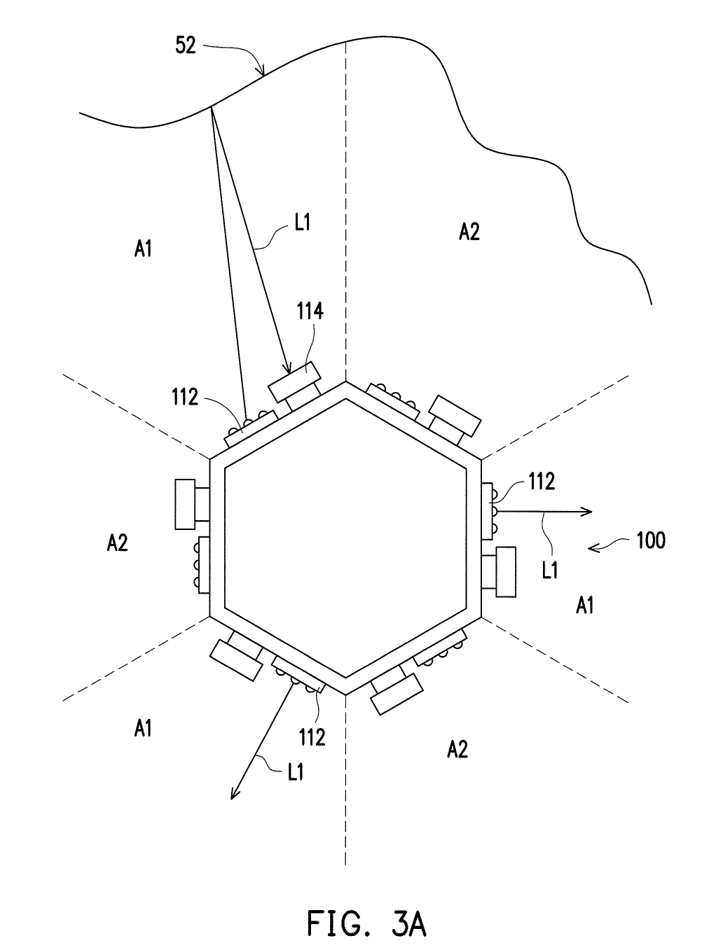

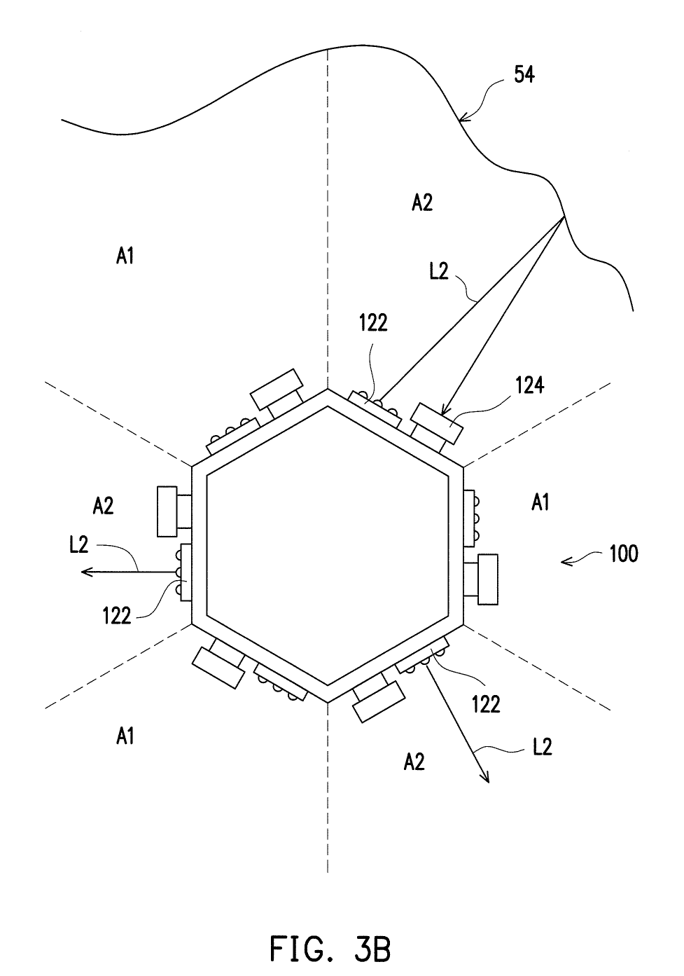

Referring to FIG. 3A, the first light source 112 is adapted to emit a first light L1 to a first detection area A1. The first depth detection component 114 is adapted to receive the first light L1 reflected from the first detection area A1, so as to acquire the first depth information. Specifically, the number of the first detection area A1 varies according to the number of the first image capturing module 110, and the plurality of first detection areas A1 respectively cover different positions.

For example, the image capturing device 100 of the present embodiment, for instance, includes three first image capturing modules 110. Therefore, the three first image capturing modules 110 capture the related information of the three different first detection areas A1 respectively along three different angles. The three first detection areas A1 have spaces therebetween and do not overlap each other. The first light L1 emitted by the first light source 112 of the first image capturing module 110 is, for example, reflected by the object surface 52 in the first detection area A1, and received by the first depth detection component 114. Therefore, the first depth detection component 114 can analyze the distance between the object surface 52 and the first image capturing module 110 with the received first light L1.

Referring to FIG. 3B, the second light source 122 is adapted to emit a second light L2 to a second detection area A2. The second depth detection component 124 is adapted to receive the second light L2 reflected from the second detection area A2, so as to acquire the second depth information. Specifically, the number of the second detection area A2 of the present embodiment varies according to the number of the second image capturing module 120, and the plurality of second detection areas A2 respectively cover different positions.

For example, the image capturing device 100 of the present embodiment, for instance, includes three second image capturing modules 120. Therefore, the three second image capturing modules 120 capture the related information of the three different second detection areas A2 respectively along three different angles. The three second detection areas A2 have spaces therebetween and do not overlap each other. More specifically, the first detection areas A1 and the second detection areas A2 of the present embodiment are complementary to each other, and can patch into a whole detection area with each other.

The second light L2 emitted by the second light source 122 of the second image capturing module 120 is, for example, reflected by the object surface 54 in the second detection area A2, and received by the second depth detection component 124. Therefore, the second depth detection component 124 can analyze the distance between the object surface 54 and the second image capturing module 120 with the received second light L2.

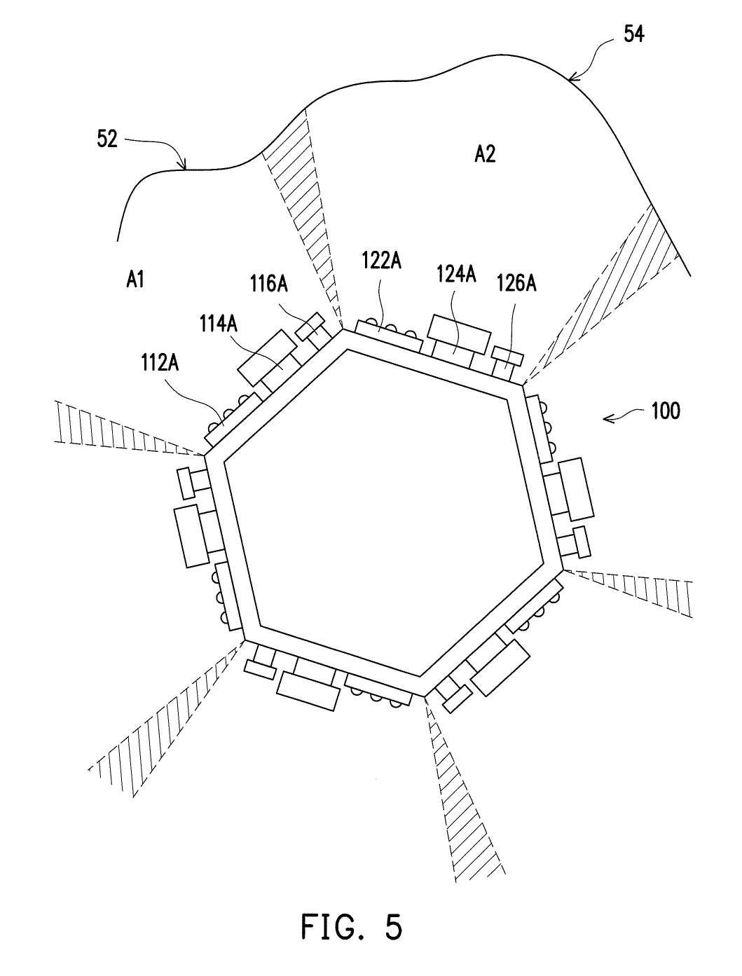

As described above, the first detection area A1 and the second detection area A2 of the present embodiment are substantially adjacent to each other or partially overlapped (as shown in the slash area in FIG. 5). The first light source 112 of the first image capturing module 110 and the second light source 122 of the second image capturing module 120 alternately emit the first light L1 and the second light L2. In other words, when the first light source 112 emits a first light L1, the second light source 122 is in a condition of suspending light emission, and does not emit light beam. When the second light source 122 emits a second light L2, the first light source 112 is in a condition of suspending light emission, and does not emit light beam.

Therefore, when the first image capturing modules 110 of the present embodiment are capturing the first depth information, the first lights L1 emitted by the first light sources 112 of the first image capturing modules 110 do not interfere with each other. That is, the first depth detection components 114 do not receive the first lights L1 of the first light sources 112 from the other first image capturing modules 110. Also, because the second light sources 122 suspend light emission when the first light sources 112 emit the first lights L1, the first depth detection components 114 are also not affected by the second lights L2. Similarly, when the second image capturing modules 120 are capturing the second depth information, the second depth detection components 124 of the second image capturing modules 120 do not receive the second lights L2 of the second light sources 122 from the other second image capturing modules 120, and are not affected by the first lights L1.

It can be understood from the described above, when the first depth detection components 114 and the second depth detection components 124 of the present embodiment are respectively detecting the first depth information and the second depth information, they do not interfere with each other and cause noise or deviation. Therefore, the first image capturing module 110 and the second image capturing module 120 can both effectively capture the first depth information and the second depth information.

On the other hand, the image capturing device 100 of the present embodiment can receive wide-angle depth information by alternately driving the first image capturing modules 110 and the second image capturing modules 120. That is, the depth information around the image capturing device 100 can all be captured by the first image capturing module 110 and the second image capturing module 120, and the overall noise is not increased.

Specifically, referring to FIG. 2, in the present embodiment, the first image capturing modules 110 and the second image capturing modules 120 are disposed around a central axis C. More specifically, the three first image capturing modules 110 and the three second image capturing modules 120 alternately surround a hexagonal area. The first light source 112 of the first image capturing module 110 and the second light source 122 of the second image capturing module 120 emit the first light L1 and the second light L2 outward with the central axis C as the center. Therefore, the first light L1 does not emit from adjacent areas, and the second light L2 does not emit from adjacent areas.

Because the three first image capturing modules 110 of the present embodiment capture three first depth information respectively along different angles, and the three second image capturing modules 120 capture three second depth information respectively along different angles, the three first detection areas A1 and the three second detection areas A2 alternately surround the image capturing device 110 along the central axis C, so as to acquire a complete environment depth information.

On the other hand, the first light source 112 of the first image capturing module 110 and the second light source 122 of the second image capturing module 120 of the present embodiment are, for example, laser light sources. Therefore, the first depth detection component 114 can calculate the distance between an object and the first image capturing module 110 according to the propagation time of the first light L1. The second depth detection component 124 can calculate the distance between an object and the second image capturing module 120 according to the propagation time of the second light L2.

More specifically, the first light L1 and the second light L2 emitted from the first light source 112 and the second light source 122 are, for example, invisible light. Therefore, the first light L1 and the second light L2 do not cause visual interference and burden to surrounding users.

Referring to FIG. 2, the image capturing device 100 of the present embodiment further includes a control device 130. The control device 130 is disposed in the housing, and electrically connected to all the first image capturing modules 110 and all the second image capturing modules 120 on the housing, and alternately activates the first image capturing modules 110 and the second image capturing modules 120. Specifically, the control device 130 is, for example, a motherboard, which is adapted to alternately drive the first light source 112 of the first image capturing module 110 to emit the first light L1 and the second light source 122 of the second image capturing module 120 to emit the second light L2. Moreover, the control device 130 is adapted to alternately drive the first depth detection component 114 and the second depth detection component 124 to receive the first light L1 and the second light L2 to generate the first depth information and the second depth information. In the present embodiment, the first light source 112 and the first depth detection component 114 are controlled based on a synchronized control method by the control device 130, and the second light source 122 and the second depth detection component 124 are also controlled based on a synchronized control method by the control device 130. That is to say, the first light source 112 and the first depth detection component 114 are turned on and off simultaneously. The second light source 122 and the second depth detection component 124 are also turned on and off simultaneously. In addition, in other embodiments, the control device 130 alternately drives the first light source 112 and the second light source 122, and controls the first depth detection component 114 and the second depth detection component 114 to be in a turned on state continuously. As seen in FIG. 2, in the present embodiment, a condition of configuring a single control device 130 is illustrated as an example. The configured position and number of control device 130 in the present embodiment can be adjusted and varied appropriately according to actual usage requirements.

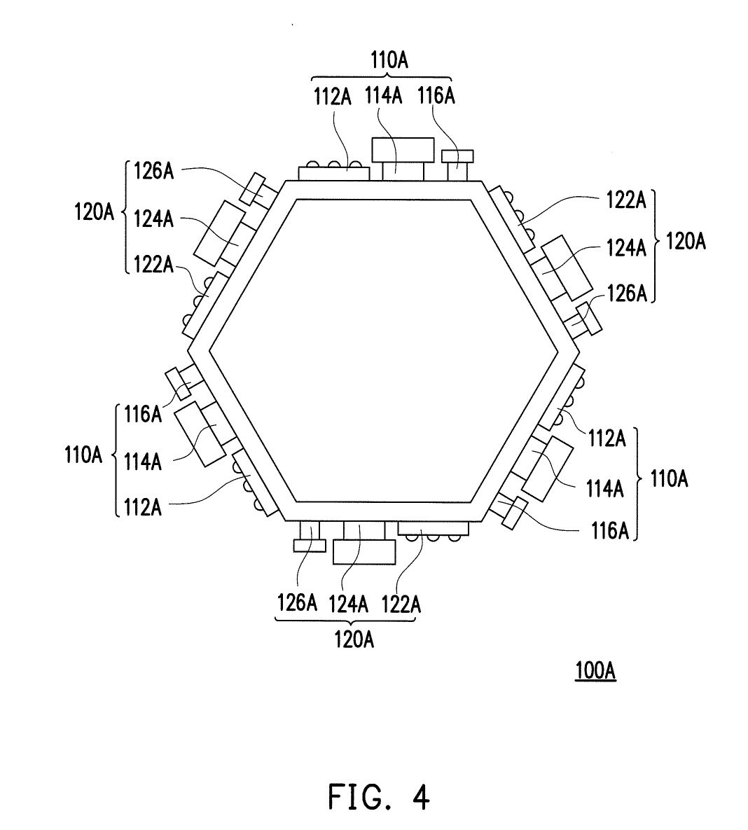

FIG. 4 and FIG. 5 are schematic diagrams of the image capturing device according to the second embodiment of the present invention. Referring to FIG. 4, the image capturing module 100A of the second embodiment of the present invention is similar to the image capturing module 100 described above. The only difference is that the first image capturing module 100A further includes a first image capturing component 116A, and the second image capturing module 120A further includes a second image capturing component 126A.

Referring to FIG. 5, in the second embodiment of the present invention, the first image capturing component 116A is adapted to capture an image of the first detection area A1, and the second image capturing component 126A is adapted to capture an image of the second detection area A1. In the present embodiment, the first detection area A1 and the second detection area A2 are partially overlapped (as shown in the slash area in FIG. 5). Specifically, the first image capturing module 110A of the present embodiment can emit a first light with the first light source 112A, and receive the first light with the first depth detection component 114A, so as to acquire a first depth information, and the first image capturing component 116A can capture an image of the first detection area A1. Therefore, the image capturing device 100A can then perform deviation calibration to a depth information with the image of the first detection area A1, so as to ensure that the first image capturing module 110A can acquire favorable first depth information. Similarly, because the second image capturing module 120A of the present embodiment includes the second light source 122A, the second depth detection component 124A and the second image capturing component 126A, the second depth information acquired from the second depth detection component 124A can be calibrated with the image of the second detection area A2 captured by the second image capturing component 126A, so as to ensure that the second image capturing module 120A can acquire favorable second depth information.

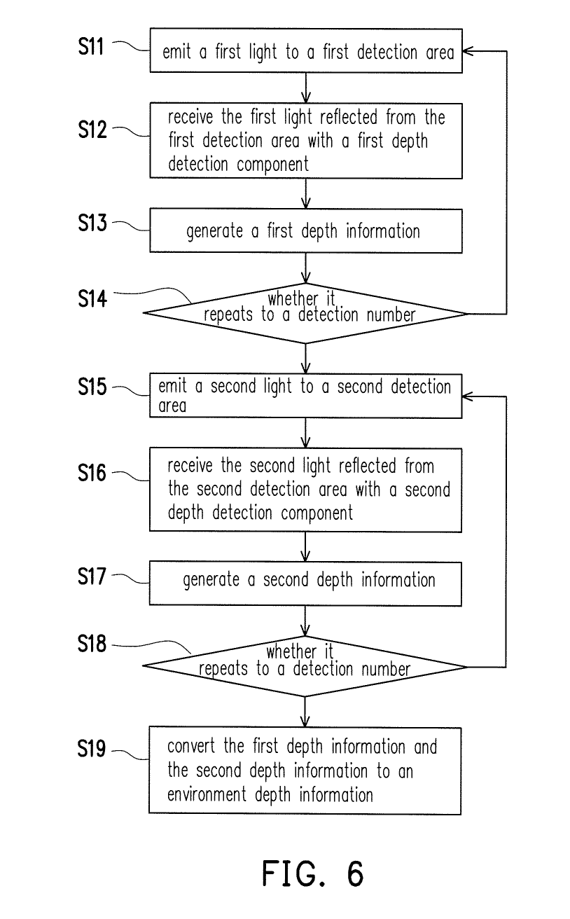

FIG. 6 is a schematic flowchart of the image capturing method according to the first embodiment of the present invention. It can be understood from the described above, the image capturing method of the first embodiment of the present invention includes driving a first depth detection step, driving a second depth detection step and converting the first depth information and the second depth information to an environment depth information. Specifically, referring to FIG. 6, the first depth detection step includes emitting a first light L1 to a first detection area A1 (step S11); and receiving the first light reflected from the first detection area with the first depth detection component 112 (step S12), and generating a first depth information (step S13). The second depth detection step includes emitting a second light L2 to a second detection area A2 (step S15), and the second detection area A2 and the first detection area A1 are adjacent to each other or partially overlapped; and receiving the second light L2 reflected from the second detection area A2 with the second depth detection component 124 (step S16), and generating a second depth information (step S17), wherein the first light L1 and the second light L2 are alternately emitted.

In other words, the image capturing method of the present invention emit light in an alternate way and capture the depth information of areas adjacent to each other. Therefore, the first light and the second light do not interfere with each other, and maintain both the first depth information and the second depth information in good quality.

More specifically, the image capturing method of the present embodiment further includes determining whether the number of the first depth information reaches a detection number after generating the first depth information (step S13). If the number of the first depth information does not reach the detection number described above, it returns to the previous step and emits the first light to the first detection area (step S11) again. In other words, the image capturing method of the present invention is not limited to the detection number of the first depth information. Users can even adjust different detection numbers of the first depth information according to the needs of calculating methods or analysing methods, so as to acquire appropriate first depth information.

Similarly, the image capturing method of the present invention also determines whether the number of the second depth information reaches a detection number (step S18) after generating the first depth information (step S13), so as to generate appropriate second depth information. Moreover, in the image capturing method of the present embodiment, the detection number of the first depth information is the same as the detection number of the second depth information, so as to acquire the first depth information and the second depth information with similar qualities.

When the image capturing method of the present embodiment acquires enough first depth information and second depth information, it converts the first depth information and the second depth information to an environment depth information (step S19). Specifically, the first depth information is, for example, an image cloud that records the depth information of each point, the second depth information is, for example, an image cloud that records the depth information of each point of adjacent areas, and the environment depth information described above, for example, combines the two image clouds with the iterative closest point (ICP) method. Therefore, the environment depth information can include wide-angle depth information, however the present invention is not limited thereto. In other embodiments, the combination of each depth information in the image capturing method can further be done with other appropriate methods.

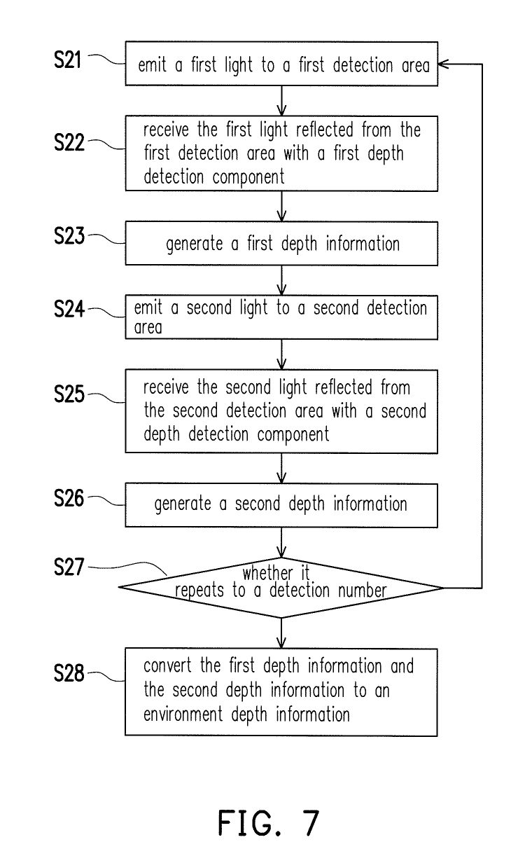

The image capturing method of the embodiment of the present invention is not limited to the image capturing method of the first embodiment described above. FIG. 7 is a schematic flowchart of the image capturing method according to the third embodiment of the present invention. Referring to FIG. 7, the image capturing method of the present invention is similar to the image capturing method of the first embodiment described above. The only difference is that the image capturing method of the present embodiment emits a first light to a first detection area (step S21), receives the first light reflected from the first detection area with the first depth detection component (step S22), emits a second light to the second detection area (step S24) after generating the first depth information (step S23), receives the second light reflected from the second detection area with the second depth detection component (step S25), and generates the second depth information (step S26) in sequence, and determines whether the number of the first depth information and the second depth information reaches a detection number after generating the first depth information and the second depth information in sequence.

In other words, the first depth detection step and the second depth detection step of the image capturing method of the third embodiment of the present invention repeatedly drive alternately, and convert the first depth information and the second depth information to an environment depth information after the number of first depth information and second depth information alternately acquired achieve a detection number.

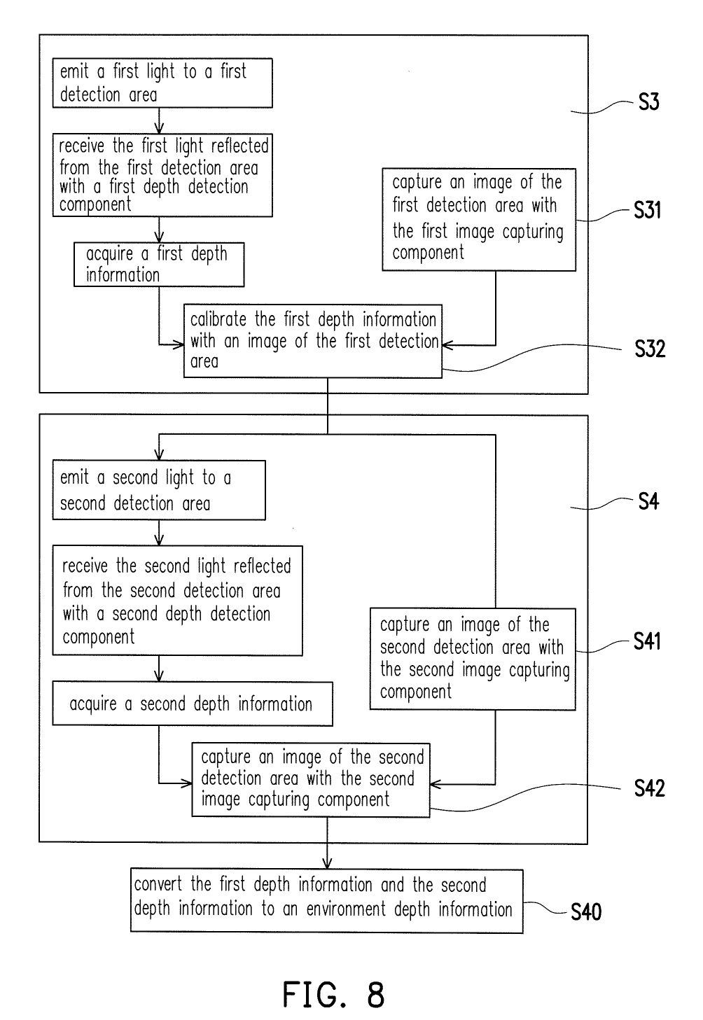

FIG. 8 is a schematic flowchart of the image capturing method according to the fourth embodiment of the present invention. Referring to FIG. 8, the image capturing method of the present embodiment is similar to the image capturing method of the third embodiment described above. The only difference is that the step S3 of driving the first image capturing module in the image capturing method of the present embodiment further includes capturing the image of the first detection area with the first image capturing component (step S31) at the same time as acquiring the first depth information. Also, the step S4 of driving the second image capturing module further includes capturing an image of the second detection area with the second image capturing component (step S41) at the same time as acquiring the second depth information.

In the step S3 of driving the first image capturing module in the present embodiment, the first depth information is calibrated with the image of the first detection area (step S32) after acquiring the first depth information and the image of the first detection area. In the step S4 of driving the second image capturing module, the second depth information is calibrated with the image of the second detection area (step S42) after acquiring the second depth information and the image of the second detection area. Specifically, because the color and contour of each object in the image of the first detection area and the second detection area can be identified, by calibrating and adjusting the first depth information and the second depth information with the image of the first detection area and the second detection area, it can be better assured that the depth information of the same object is not misjudged in the first depth information and the second depth information. It can also filter noise and avoid serious distortion generated due to the first depth detection component and the second depth detection component not detecting the object. Therefore, the calibrated first depth information and second depth information described above can acquire better environment depth information after being converted to an environment depth information (step S40).

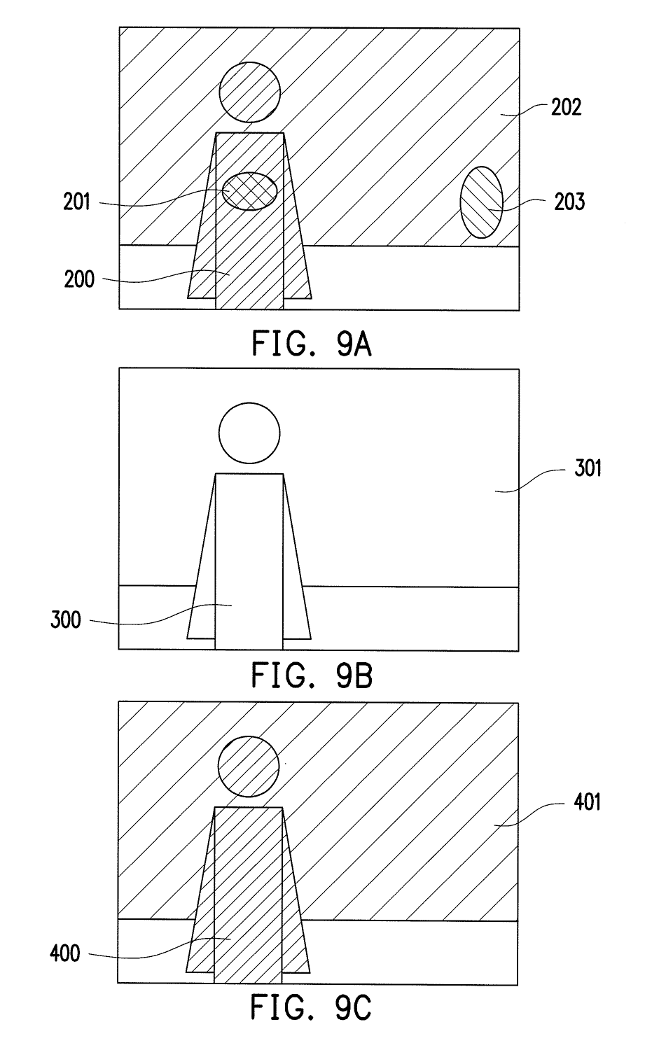

FIG. 9A to FIG. 9C are schematic diagrams of noise filtering of the depth information according to the fourth embodiment of the present invention. A step of driving the first image capturing module is described as an example as follows, however the present invention is not limited thereto. Referring to FIG. 9A, wherein the block 202 includes a noise block 203, and the block 200 includes a noise block 201.

Referring to FIG. 9B, the image capturing method of the present embodiment converts an image of the first detection area to an image contour of the first detection area. Therefore, the image capturing method of the present embodiment can determine and filter the noise block 201 in the block 200 according to the image contour block 300 and the contour block 301 of the first detection area, and also filter the noise block 203 in the filter block 202, and acquire the first depth information illustrated in FIG. 9C. The blocks 401 and 400 can both be recorded as the same depth information.

The present invention is not limited to the noise filtering method described above, it can even remove the noise blocks 201 and 203 in the blocks 200 and 202 directly to decrease the calculation time of the image capturing method in other embodiments.

To sum up, the image capturing device of the embodiment of the present invention can detect wide-angle depth information and not increase noise, because it includes a first image capturing module and a second image capturing module that alternately emit a first light and a second light. The image capturing method of the embodiment of the present invention can acquire wide-angle depth information and not increase the noise of the depth information, because it alternately drives the first depth detection step and the second depth detection step.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image capturing device, comprising:
at least one first image capturing module, comprising:
a first light source, adapted to emit a first light to a first detection area; and
a first depth detection component, adapted to receive the first light reflected from the first detection area so as to acquire a first depth information; and
at least one second image capturing module, comprising:
a second light source, adapted to emit a second light to a second detection area; and
a second depth detection component, adapted to receive the second light reflected from the second detection area, so as to acquire a second depth information,
wherein the first detection area and the second detection area are substantially adjacent to each other or partially overlapped, and the first light source of the at least one first image capturing module and the second light source of the at least one second image capturing module alternately emit the first light and the second light.

2. The image capturing device as claimed in claim 1, wherein the at least one first image capturing module further comprises a first image capturing component, the at least one second image capturing module further comprises a second image capturing component, the first image capturing component is adapted to capture an image of the first detection area, the second image capturing component is adapted to capture an image of the second detection area.

3. The image capturing device as claimed in claim 1, wherein the at least one first image capturing module and the at least one second image capturing module are disposed around a central axis, and the first light source of the at least one first image capturing module and the second light source of the at least one second image capturing module emit the first light and the second light outward with the central axis as a center.

4. The image capturing device as claimed in claim 1, wherein the first depth detection component of the at least one first image capturing module calculates a distance according to a propagation time of the first light, and the second distance detection component of the at least one second image capturing module calculates a distance according to a propagation time of the second light.

5. The image capturing device as claimed in claim 1, wherein the first light source of the at least one first image capturing module and the second light source of the at least one second image capturing module are laser light sources.

6. The image capturing device as claimed in claim 1, further comprises a control device, electrically connected to the at least one first image capturing module and the at least one second image capturing module, the control device alternately activates the at least one first image capturing module and the at least one second image capturing module.

7. The image capturing device as claimed in claim 1, comprises three first image capturing modules and three second image capturing modules, the three image capturing modules and the three second image capturing modules are alternately disposed and surround a central axis, the three first image capturing modules capture the three first depth information respectively along different angles, the three second image capturing modules capture the three second depth information respectively along different angles, the three first detection areas and the three second detection areas alternately surround the image capturing device along the central axis.

8. The image capturing device as claimed in claim 1, wherein the first detection area and the second detection area are substantially complementary.

9. An image capturing method, comprising:
driving a first depth detection step, comprising:
emitting a first light to a first detection area; and
receiving the first light reflected from the first detection area by a first depth detection component, so as to generate a first depth information;
driving a second depth detection step, comprising:
emitting a second light to a second detection area, and the second detection area and the first detection area are adjacent or partially overlapped; and
receiving the second light reflected from the second detection area by a second depth detection component, so as to generate a second depth information, wherein the first light and the second light are alternately emitted; and
converting the first depth information and the second depth information to an environment depth information.

10. The image capturing method as claimed in claim 9, wherein the first depth detection step further comprises:
capturing an image of the first detection area by a first image capturing component; and
calibrating the first depth information according to the image of the first detection area, and the second depth detection step further comprises:
capturing an image of the second detection area by a second image capturing component; and
calibrating the second depth information according to the image of the second detection area.

11. The image capturing method as claimed in claim 10, the step of calibrating the first depth information according to the image of the first detection area further comprises:
converting the image of the first detection area to an image contour of the first detection area; and
adjusting the first depth information according to the image contour of the first detection area,
and a step of calibrating the second depth information according to the image of the second detection area further comprises:
converting the image of the second detection area to an image contour of the second detection area; and
adjusting the second depth information according to the image contour of the second detection area.

12. The image capturing method as claimed in claim 9, wherein after the first depth detection step repeatedly executes a number of measurements, the second depth detection step repeatedly executes the number of measurements.

13. The image capturing method as claimed in claim 9, wherein the first depth detection step and the second depth detection step repeatedly drive alternately.

14. The image capturing method as claimed in claim 9, wherein the first detection area and the second detection area are substantially complementary.
